(19) United States
(12) Patent Application Publication
(10) Pub. No.: US 2011/0205101 A1
(43) Pub. Date: Aug. 25, 2011

(54) Systems and/or methods for using coherent electromagnetic waves in a missile defense shield

(75) Inventor: Aris Mardirossian, Potomac, MD (US)

(73) Assignee: Technology Patents, LLC, Potomac, MD (US)

(21) Appl. No.: 12/659,034

(22) Filed: Feb. 23, 2010

(51) Int. Cl. G01S 7/38

(52) U.S. Cl. 342/14

(57) ABSTRACT

Certain example embodiments of this invention relate to a holography-based missile defense shield. In certain example embodiments, an EM field is created on or proximate to a missile. Based on imaging and/or trajectory data, a holographic plate is prepared such that a holographic projection may be generated therefrom. Electromagnetic waves are then focused on the holographic plate as a reference beam so that the holographic image is generated. In certain example embodiments, the holographic image may correspond to the missile itself, a portion of the missile, a substantially planar shape, a substantially three-dimensional shape, and/or the like. In certain example embodiments, the holographic image focused on or near the missile will interfere with the operation of the missile such that it is damaged, destroyed, or otherwise rendered less of a threat.

### FIELD OF THE INVENTION

Certain example embodiments of this invention relate to systems and/or methods for creating missile defense shields. More particularly, certain example embodiments of this invention relate to systems and/or methods for using coherent electromagnetic (EM) waves in a missile defense shield. In certain example embodiments, a holographic EM field is created on or proximate to a missile so as to disrupt its operation and/or destroy the missile.

### BACKGROUND AND SUMMARY OF EXAMPLE EMBODIMENTS OF THE INVENTION

Since the discovery of holography in 1947, holograms have gained notoriety through science fiction television shows and movies. For instance, holograms were popularized through the “holodeck” in the Star Trek television and movie franchise. Today, holograms are widely recognizable in security-type applications such as, for example, logos on credit/debit cards or “officially licensed” goods, imprints on certain bank notes or bills (including certain Euro, Japanese Yen, British Pound, Canadian Dollar, and/or other bank notes or bills), in “identigrams” (such as those used in Germany), and/or the like. Another recent avenue of exploration involves the use of holograms for data storage applications.

In holography, some of the light scattered from an object (or set of objects) is made to fall on a recording medium. This first set of light is often referred to as the “object beam.” A second light beam, often referred to as the “reference beam,” also illuminates the recording medium such that the object and reference beams interfere with one another. The resulting light field, which appears to be a random pattern of varying intensity, is the hologram. It the hologram is illuminated by the original reference beam (or suitable substitute reference beam, e.g., with the same wavelength, curvature, and angle), a light field is diffracted by the reference beam that is identical to the light field that was scattered by the object (or objects). Thus, someone looking into the hologram “sees” the objects even though it may no longer be present.

In a typical recording process used for a complex object, a laser beam is split into two separate beams of light using a beamsplitter (e.g., typically half-silvered glass or a birefringent material). One beam (the object beam) illuminates the object, reflecting the object's image onto the recording medium as it scatters the beam, and the second beam (the reference beam) illuminates the recording medium directly. According to diffraction theory, each point in the object acts as a point source of light. Each of these point sources interferes with the reference beam, giving rise to an interference pattern. The resulting pattern is the sum of the point source and reference beam interference patterns.

In a typical reproduction process used in connection with transmission-type holograms, the holographic plate is illuminated by the reference beam (or a suitable substitute, as described above). When this happens, each point source diffraction grating will diffract part of the reference beam to reconstruct the wavefront from its point source, and these individual wavefronts add together to reconstruct the whole of the object beam. In so doing, a viewer will be able to perceive a wavefront that is identical to the scattered wavefront of the object illuminated by the reference beam such that the viewer sees an image (or holographic projection) of the original object. This image is sometimes known as a “virtual image.” The direction of the light source seen illuminating the virtual image is that of the original illuminating beam. As indicated above, to reconstruct the object exactly from a transmission hologram, the reference beam must have the same wavelength and curvature, and must illuminate the hologram at the same angle as the original reference beam (i.e., only the phase can be changed). If these conditions are not met, then the virtual image will appear as a distorted version of the original object. Other types of holograms, such as reflection holograms, also are known.

Although holography techniques have been in place for some years, the inventor of the instant application has realized that holograms have potential uses in fields beyond those described above. In this regard, the inventor of the instant application has realized that holograms that work with non-optical beams have potential uses in the defense industry. More particularly, the inventor of the instant application has realized that one area where non-optical beam holography may be especially advantageous is in defense applications where it is desirable to intercept, interrupt, and/or otherwise interfere with a missile or other incoming projectile.

Thus, one aspect of certain example embodiments of this invention pertains to techniques for using coherent electromagnetic (EM) wave related holography to help establish a missile defense shield. More particularly, in certain example embodiments, a holographic EM field is created on or proximate to a missile so as to disrupt its operation and/or destroy the missile.

In certain example embodiments of this invention, a method of disrupting an in-flight projectile is provided. Characteristics of the projectile are determined via an imaging system. A hologram is generated based on the determined characteristics. At least one holographic image is projected on or proximate to the projectile, with the at least one holographic image being projected in connection with a substantially coherent electromagnetic wave source. A magnetic field corresponding to the projected at least one holographic image interferes with the otherwise normal operation of the projectile, thereby damaging or destroying said projectile.

In certain example embodiments of this invention, a projectile defense system is provided. An imaging system is configured to determine characteristics of the projectile. A controller is configured to generate a hologram based on the determined characteristics. A holographic projection system is configured to project at least one holographic image on or proximate to the projectile, with the at least one holographic image being projected in connection with a substantially coherent electromagnetic wave source. A magnetic field corresponding to the projected at least one holographic image interferes with the otherwise normal operation of the projectile, thereby damaging or destroying said projectile. The determined characteristics include size, shape, and trajectory of the missile.

According to certain example embodiments, an air-, land-, or sea-based vehicle may include such a system. According to certain example embodiments, such a vehicle may include shielding placed on the vehicle such that any fields emanating from the holographic projection system do not interfere with proper operation of the vehicle.

The features, aspects, advantages, and example embodiments described herein may be combined to realize yet further embodiments.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a schematic view of an illustrative system imaging a missile in accordance with an example embodiment;

FIG. 2 is a schematic view of an illustrative system projecting a holographic image on a missile in accordance with an example embodiment;

FIG. 3 is a schematic view of an illustrative system projecting a substantially planar holographic image in a missile's path in accordance with an example embodiment;

FIG. 4 is a schematic view of an illustrative system projecting a substantially three-dimensional holographic image in a missile's path in accordance with an example embodiment; and

FIG. 5 is a flowchart showing an illustrative process for creating a missile defense shield in accordance with an example embodiment.

### DETAILED DESCRIPTION OF EXAMPLE EMBODIMENTS OF THE INVENTION

Certain example embodiments relate to systems and/or methods for using coherent electromagnetic (EM) waves in a missile defense shield. In certain example embodiments, a holographic EM field is created on or proximate to a missile so as to disrupt its operation and/or destroy the missile. In certain example embodiments, the missile is imaged and/or its trajectory is calculated. Based on this data, a holographic plate is prepared such that a holographic projection may be generated therefrom. Electromagnetic waves are then focused on the holographic plate as a reference beam so that the holographic image is generated. In certain example embodiments, the holographic image may correspond to the missile itself, a portion of the missile, a substantially planar shape, a substantially three-dimensional shape, and/or the like. In certain example embodiments, the holographic image focused on or near the missile will interfere with the operation of the missile such that it is damaged, destroyed, or otherwise rendered less of a threat.

Prior attempts to create missile defense shields of various different kinds have met with varying degrees of success. For example, Patriot Missiles were effectively deployed during the First Gulf War to intercept Iraqi scud missiles attempting to reach the United States' foreign-deployed forces and allies in Kuwait and Israel. Not all projects have been so successful, however. For instance, the “Star Wars” initiative proposed during the Reagan Administration never fully developed or deployed. The Bush Administration's attempt to revive a Star Wars like program became mired in controversy regarding, among other things, its effectiveness and necessity. Although several Eastern European allies were initially promised a missile defense shield, this project appears to have been put on hold for political and/or other reasons. From these and/or other examples, it will be appreciated that there still is a need for an effective missile defense shield option.

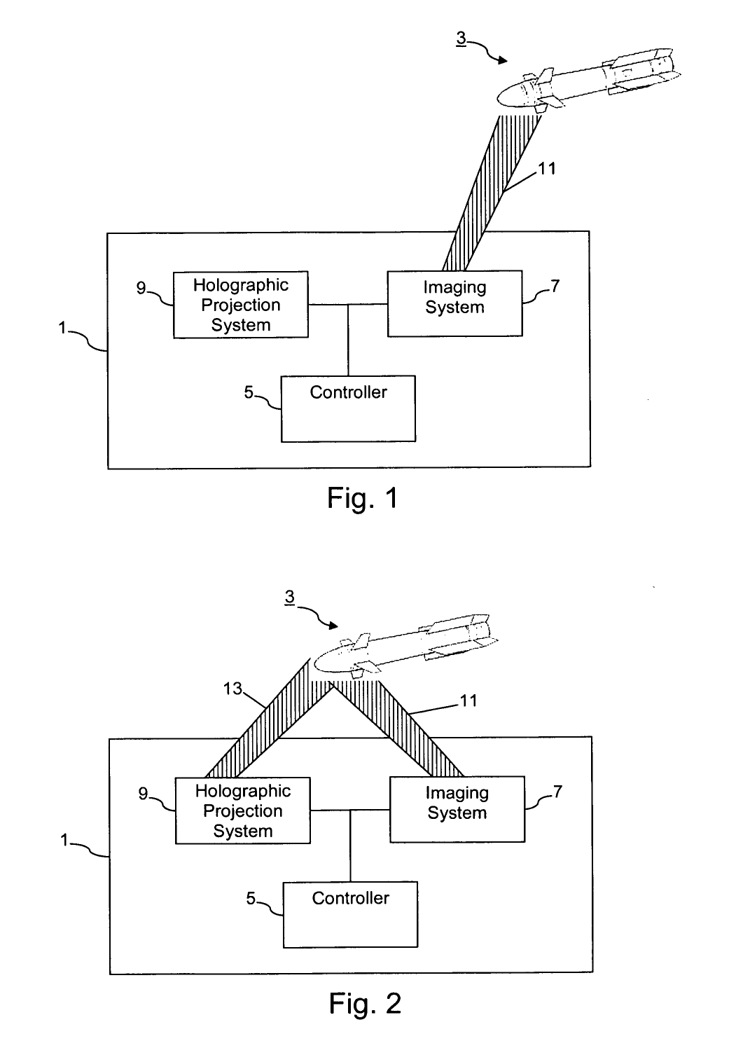

Bearing this in mind, FIG. 1 is a schematic view of an illustrative system 1 imaging a missile 3 in accordance with an example embodiment. In the missile defense system 1, a controller 5 coordinates activities between an imaging system 7 and a holographic projection system 9. In certain example embodiments, the controller 5 may include a processor and a memory, and may be configured to execute instructions (e.g., method steps) tangibly stored on a computer readable storage medium so as to cause the system 1 to perform the herein described and/or other functions. In certain example embodiments, the controller 5 may comprise any suitable form of programmed logic circuitry (e.g., hardware, software, firmware, and/or the like).

In any event, in certain example embodiments, the imaging system 7 is directed at missile 3 so as to help determine characteristics of the missile. Such characteristics may include, for example, size, shape, velocity, heading or trajectory, and/or the like. It will be appreciated that although at least some of this information may be obtained directly from the imaging system 7, other data may be calculated or inferred (e.g., by the controller 5) from raw data obtained via the imaging system 7. In certain example embodiments, the imaging system 7 itself may comprise a RADAR, LIDAR, GPS, photographic and/or thermal imaging, and/or other data gathering sub-systems. In some such cases, a beam 11 may be directed at the missile 3 from the imaging system 7, e.g., as shown in FIG. 1.

As alluded to above, the imaging system 7 may help determine precise characteristics of the missile 3, and the controller 5 may take such data from the imaging system 7 to develop a holographic plate for a holographic image to be created by the holographic projection system 9. The development of a holographic plate is possible because all (or substantially all) of the interactions between the object and reference beams, as well as the shapes of the interference fringes, can be modeled using known mathematical equations. Given this model, it is possible to print a suitable pattern onto a holographic plate, thereby indirectly creating a hologram. As explained in greater detail below, holographic plates for various different holographic images may be produced in dependence upon the example implementation. Briefly, the holographic plate may correspond to, for example, the entire missile 3, one or more portion(s) of the missile 3, a single substantially planar shape, multiple substantially planar shapes, a single substantially three-dimensional shape, multiple substantially three-dimensional shapes, etc. In certain example embodiments, multiple holographic plates may be produced.

FIG. 2 is a schematic view of an illustrative system 1 projecting a holographic image on a missile 3 in accordance with an example embodiment. Using the holographic plate prepared above, the holographic projection system 9 may superimpose a holographic image on the missile 3. This may be accomplished through the use of a substantially coherent electromagnetic (EM) wave source in conjunction with the holographic plate. It will be appreciated that the substantially coherent electromagnetic (EM) wave source will produce substantially in-phase energy that has substantially the same wavelength. In other words, substantially coherent EM radiation 13 will combine with the holographic plate to produce a magnetic field image of the missile 3. In certain example embodiments, shielding may be provided to absorb and/or protect the system 1 and/or any operators thereof. For instance, lead and/or other shields may be provided around the area of the patient's body that is to be irradiated.

In the FIG. 2 example, the holographic image is projected directly on the missile 3. The holographic image that is projected may be a copy of the missile 3 itself in certain example embodiments. In certain example embodiments, the holographic image that is projected may be one or more portions of the missile 3 (e.g., the tip, shaft, or other portion(s)). In still other example embodiments, the image projected on the missile 3 may be one or more substantially planar and/or three-dimensional shape(s). For example, planes, cubes, spheres and/or the like may be projected on the missile 3 via the holographic projection system 9. When a strong electromagnetic field is created on the missile 3, control circuitry located therein may be caused to malfunction, e.g., through exposure to the strong magnetic waves. As is known, the presence of strong magnetic forces can disrupt magnetic memories and the operation of microprocessors. The EM field generated by the holographic image may in certain example embodiments provide such strong magnetic forces. The EM field also or in the alternative may be caused to act directly on metal housings of missiles, when possible, in certain example embodiments.

The creation of a “moving” holographic image is considered difficult. It is still possible in certain example embodiments to create a moving holographic image using conventional techniques. It will be appreciated that the movement of the image may correspond to the movement of the missile 3. This may be complex in the case of missiles that dynamically alter their courses or are otherwise controlled, but repeated (and in some cases continuous) imaging, holographic plate printing, and projection can be used to update the trajectory as necessary. In a similar fashion, multiple fixed snapshots can be “stitched” together to simulate or otherwise approximate the behavior of a moving hologram, much as a flipbook can approximate higher-quality animations.

However, in certain example embodiments, these techniques can be simplified by causing the plate and beam 13 to move in accordance with the actual, anticipated, or updated trajectory so that the ultimate holographic image moves in a way that matches or mimics the movement of the missile 3. In other words, the mathematical computations may be simplified and the need for many rapidly produced holographic plates can be reduced by indexing the movement of the holographic image to the movement of the missile 3, e.g., so that the image does not move relative to the missile 3. This may be accomplished by providing a two-axis tracking system to the holographic projection system 9 to help account for the X-Y movement of the missile 3 and feeding data from the imaging system 7 and/or the controller 5 to the holographic projection system 9 so that the image moves. Vertical movement of the image may be enabled by providing a third tracking axis in certain example embodiments. In certain example embodiments, vertical movement also may be accomplished by changing the position of the EM energy source relative to the plate and/or using known techniques to “zoom in” or “zoom out” (e.g., magnify or de-magnify) as appropriate.

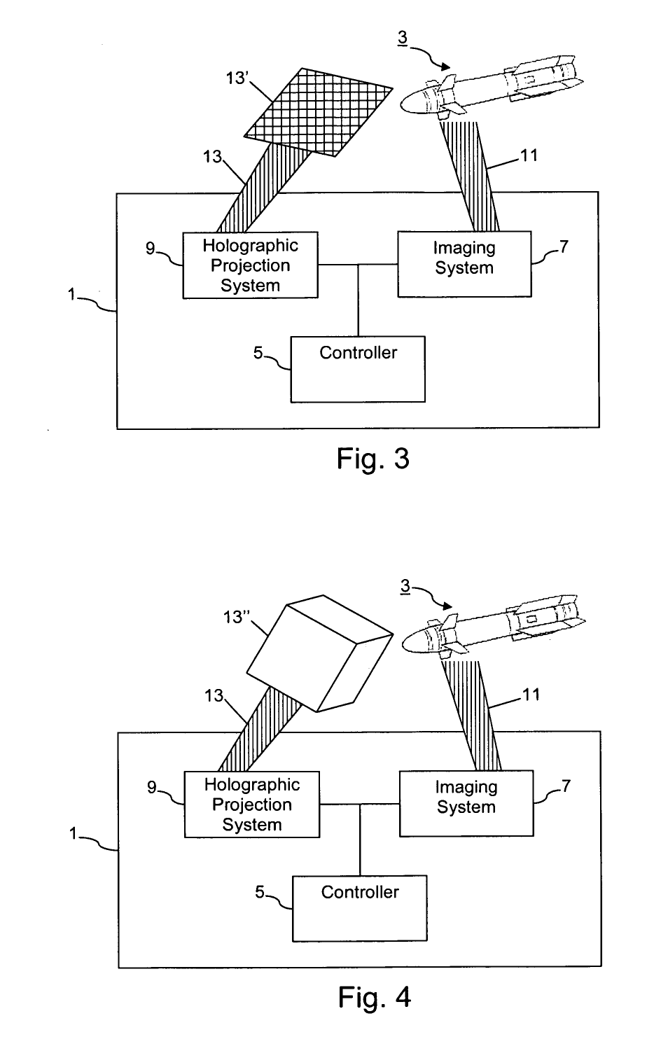

FIG. 3 is a schematic view of an illustrative system 1 projecting a substantially planar holographic image 13′ in a missile's path in accordance with an example embodiment. As explained above in connection with the FIG. 2 example, certain example embodiments may project a holographic image directly on the missile 3. Alternatively, or in addition, certain example embodiments, may project a holographic image in the path of the missile 3. This possibility is shown schematically in FIG. 3, where the beam 13 creates a substantially planar holographic image 13′. This substantially planar holographic image 13′ is in the path of the missile 3, such that the missile 3 will pass through it, causing damage or disruption to the circuitry therein. Although a square is shown in the FIG. 3 example, it will be appreciated that other shapes, sizes, and/or image configurations may be provided in connection with different embodiments of this invention. For example, circular, ovular, rectangular, etc., shapes may be used in connection with certain example embodiments of this invention.

Providing a stationary holographic image 13′ may be advantageous in that, for example, it is not necessary to direct the image on the missile 3 itself, which may be traveling extremely quickly. Providing a stationary holographic image 13′ also ay be advantageous is that, for example, the need to create a moving hologram (or multiple holograms that approximate a moving hologram) may be reduced. In addition, the holographic image 13′ may be sized, located, and spatially oriented such that substantially all of the missile 3 passes therethrough, which may be difficult to accomplish with a fast-moving object that may take an unexpected path.

In certain example instances, the holographic image 13′ may be at least as large as (and in some cases, 2×, 3×, 5×, or some other factor larger than) the widest diameter of the missile 3, and it may be spatially oriented such that it is substantially orthogonal to the path of the missile 3.

As indicated above, in certain example embodiments, multiple substantially planar holographic images 13′ may be provided. Each said holographic image may have substantially the same or a different shape. In certain example embodiments, the multiple images may be substantially parallel and spaced apart from one another. In certain example embodiments, the multiple images may be located along the apparent or expected trajectory of the missile 3.

Much like FIG. 3, FIG. 4 is a schematic view of an illustrative system 1 projecting a substantially three-dimensional holographic image 13″ in a missile's path in accordance with an example embodiment. It will be appreciated that the foregoing description related to FIG. 3 also applies with respect to FIG. 4, except that substantially three-dimensional images are created rather than substantially planar images. Creating substantially three-dimensional images may be desirable to increase the size of the electromagnetic field produced. Although a cube is shown in the FIG. 4 example, it will be appreciated that other shapes, sizes, and/or image configurations may be used in connection with different embodiments of this invention. Such shapes may include, for example, more rectangular prisms, spheres, football-shaped images, etc.

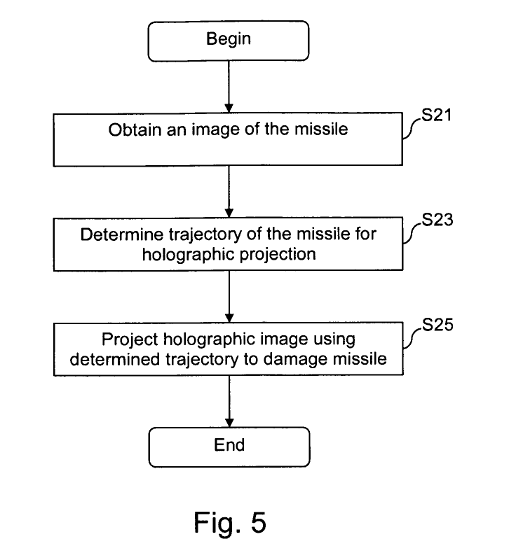

FIG. 5 is a flowchart showing an illustrative process for creating a missile defense shield in accordance with an example embodiment. An image of a missile or other projectile is obtained in step S21. From this image, in step S23, characteristics of the missile or other projectile are determined. Such characteristics may include, for example, size, shape, special orientation, trajectory, and/or the like. In step S25, a holographic image may be projected on or in the path of the missile using the determined characteristics. The holographic image may be formed using coherent electromagnetic (EM) waves, such that the field becomes a magnetic field. This strong magnetic field may cause interfere with the operation of the missile or other projectile. For instance, electrical components may cease to operate as normal, the missile or other projectile may be knocked off-target, etc. This process may be repeated in whole or in part, e.g., so as to cause more and more interference with the missile or other projectile, thereby potentially increasing the likelihood that the components thereof will become damaged, destroyed, or otherwise rendered inoperable.

In addition to, or in place of, the techniques described above, particles, shrapnel, or other metallic material may be shot in the general direction of the missile like bird shot. However, a holographic image may cause this material to focus and/or otherwise congregate on the missile or an area proximate to the missile. In other words, the strong magnetic field corresponding to the image will capture the material, thereby either attacking the missile directly or creating a shield-like obstacle in the missile's path that will cause it damage. This process also may be repeated multiple times in order to damage the missile.

In certain example embodiments, for magnetic projectiles such as bullets and the like, holographic images may be created to slow them down to a velocity at which they will not substantially damage a target. This may be accomplished by attempting to catch and hold the targets, providing one or more images that attempt to redirect or slow the targets, etc. In certain example embodiments, once a target has been sufficiently slowed, it may be possible to catch, hold, and redirect such targets. In certain example embodiments, it may also be possible to catch, hold, and simply drop such targets. In certain example embodiments, it may be possible to knock such elements off-base or off-target.

Although certain example embodiments have been described in connection with intercepting a single missile, it will be appreciated that example implementations of this invention may be capable of intercepting multiple missiles. In such embodiments, the missiles may be individually or collectively imaged, and corresponding images may be individually or collectively produced. In certain example implementations, when multiple missiles are relatively close to one another, certain example embodiments may create a large image (e.g., a larger substantially planar or substantially three-dimensional version of the above) to effectively serve as a broader net for the multiple missiles.

In additional, although certain example embodiments have been described in connection with intercepting one or more missile(s), it will be appreciated that certain example implementations of this invention may be capable of intercepting different kinds of projectiles. For instance, certain example implementations of this invention may be capable of intercepting, disabling, disarming, and/or otherwise rendering less effective missiles, torpedoes, and/or other electronic and/or metallic projectiles.

The exemplary systems described herein may be ground-based in certain example implementations. The exemplary systems described herein also may be vehicle-based. For instance, in certain example embodiments, the exemplary systems described herein may be fitted to aircraft, ships, tanks, trucks, submarines, and/or other vehicles. In still other example embodiments, the exemplary systems described herein may be connected to satellites. In cases were the exemplary systems described herein are fitted to vehicles, satellites, or the like, it may be desirable to provide shielding (e.g., in accordance with the above-described and/or other techniques) to help protect to the apparatus to which the system is connected, for example from exposure to potentially harmful EM fields.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of disrupting an in-flight projectile, the method comprising:
determining characteristics of the projectile via an imaging system;
generating a hologram based on the determined characteristics; and
projecting at least one holographic image on or proximate to the projectile, the at least one holographic image being projected in connection with a substantially coherent electromagnetic wave source,
wherein a magnetic field corresponding to the projected at least one holographic image interferes with the otherwise normal operation of the projectile, thereby damaging or destroying said projectile.

2. The method of claim 1, wherein the determined characteristics include size, shape, and trajectory of the missile.

3. The method of claim 2, wherein the at least one image is projected directly on the projectile and corresponds to at least a portion of the projectile.

4. The method of claim 3, further comprising tracking movement of the projectile and continuing to project the at least one image thereon as the projectile moves.

5. The method of claim 2, wherein the at least one image is projected I the path of the projectile.

6. The method of claim 5, wherein the at least one image is substantially planar in shape.

7. The method of claim 5, wherein the at least one image is substantially three-dimensional in shape.

8. The method of claim 5, wherein plural images are projected in the path of the projectile.

9. The method of claim 5, further comprising tracking movement of the projectile and continuing to project the at least one image in the path of the projectile as the projectile moves.

10. The method of claim 2, wherein the imaging system includes RADAR and/or LIDAR modules.

11. The method of claim 10, wherein the magnetic field of the at least one image is sufficiently strong to interfere with electronic components of the projectile.

12. A projectile defense system, comprising:
an imaging system configured to determine characteristics of the projectile;
a controller configured to generate a hologram based on the determined characteristics; and
a holographic projection system configured to project at least one holographic image on or proximate to the projectile, the at least one holographic image being projected in connection with a substantially coherent electromagnetic wave source;
wherein a magnetic field corresponding to the projected at least one holographic image interferes with the otherwise normal operation of the projectile, thereby damaging or destroying said projectile, and
wherein the determined characteristics include size, shape, and trajectory of the missile.

13. The system of claim 12, wherein the at least one image is projectable directly on the projectile and corresponds to at least a portion of the projectile.

14. The system of claim 13, further comprising a tracking system configured to match the movement of the projectile as the holographic projection system continues to project the at least one image on the projectile as the projectile moves.

15. The system of claim 12, wherein the at least one image is projected I the path of the projectile.

16. The system of claim 15, wherein plural images are projected in the path of the projectile.

17. The system of claim 15, further comprising a tracking system configured to match the movement of the projectile as the holographic projection system continues to project the at least one image on the projectile as the projectile moves.

18. The system of claim 12, wherein the imaging system includes RADAR and/or LIDAR modules.

19. An air-, land-, or sea-based vehicle comprising the system of claim 12.

20. The vehicle of claim 19, further comprising shielding placed on the vehicle such that any fields emanating from the holographic projection system do not interfere with proper operation of the vehicle.
